(19) United States
(12) Patent Application Publication
(10) Pub. No.: US 2015/0099547 A1
(43) Pub. Date: Apr. 9, 2015

(54) GEO-BASED DETECTION OF BORDER VIOLATION

(71) Applicant: Geocomply Limited, Tortola (VG)

(72) Inventor: Anna Sainsbury, Henderson, NV (US)

(21) Appl. No.: 14/507,723

(22) Filed: Oct. 6, 2014

Related U.S. Application Data
(60) Provisional application No. 61/887,295, filed on Oct. 4, 2013.

(51) Int. Cl. H04W 4/02; H04W 8/08

(52) U.S. Cl. CPC H04W 4/021; H04W 8/08
USPC 455/456.3

(57) ABSTRACT

An initial geo-location may be determined for a user of a web service from the user's connection data to establish if it is a mobile connection or not. Once the connection is identified as mobile or static and the user's location is known, the closest border and/or territory which is blocked to the user and within the geo-restricted area is determined. A future time at which the user's geo-location should be re-determined is then calculated using a variety of formula based on the connection type, location and distance to the border. The resulting calculation of desired future time of re-geolocation may be based on the user's current location, the distance to the nearest border, an estimated velocity at which the user may be moving, rules associated with the web-service, parameters set by an administrator and other factors

### CROSS-REFERENCE TO RELATED APPLICATIONS

This application claims the priority benefit of U.S. Provisional Application Ser. No. 61/887,295 titled “Geo-Based Detection of Border Violation,” filed Oct. 4, 2013, the disclosure of which is incorporated herein by reference.

### BACKGROUND

Many web-based services are provided to users within a certain location. Some such services require that users stay within a particular area. For example, some interactive services (such as gaming or access to sports broadcasts) services require that a user stay within a particular geographical area, such as a particular state, building, or other area. When a user of a geo-restricted web service is accessing the service from a static ISP, such as a landline connection in a home, office, connections that use a mobile router, or a free Wi-Fi service provided in a coffee shop, the risk of that user subsequently crossing a boundary of the area while still connected to the interactive service is low. However, when a user is accessing the geo-restricted web service using a device (such as a lap top or smart phone or tablet) through a mobile ISP (provided via cell towers) the risk may be higher.

### SUMMARY

The present technology identifies the accurate geo location of the user of a geo-restricted web service, then estimates the risk of the user subsequently exiting the allowed area and estimates when the user location needs to be re-determined before any exit to the allowed area could happen.

The user location may be determined in a variety of ways. An initial geo-location may be determined for a user of a web service. The location may be determined from the user's connection data to establish if it is a mobile connection or not. Once the connection is identified as mobile or static and the user's location is known, the closest border and/or blocked territory to the user within the geo-restricted area is determined. A future time at which the user's geo-location should be re-determined is then calculated using a variety of formula based on the connection type, location and distance to the border. The resulting calculation of desired future time of re-geolocation may be based on the user's current location, the distance to the nearest border, an estimated velocity at which the user may be moving, rules associated with the web-service, parameters set by an administrator and other factors. For example, if a user is determined to be 20 miles from the nearest state border for a web service only provided in the particular state, and the pre-set reasonable max speed in the formula is set at sixty (60) miles per hour, the user geo-location may be re-determined at fifteen minutes. When the user's new location at that time (i.e., fifteen minutes after the previous location determination) is determined to be now closer to the border of the geo-restricted web service, an action may be taken by the web service in light of the updated geo data. The action may include for example performing a repeat calculation of the time required for the next regeolocation (based on the formula described above), the user may be provided with a warning that they are close to an exclusion zone, and a portion or all of the service features provided to the user may be blocked, or some other action may be taken.

The time at which to re-determine user geo-location may be determined based on a straight line to the nearest border, based on user locations and geo-data for roads, train travel, and other travel data, as well as other data.

In embodiments, a method for determining a geographical location may.

A system for determining a geographical location may include a processor, memory and an application stored in memory and executed by the processor. The application may execute to.

### BRIEF DESCRIPTION OF THE DRAWINGS

FIGS. 1A-1B illustrates information used in determining user geographical location.

FIG. 2 is a block diagram system for implementing the present technology.

FIGS. 3-4 illustrate interfaces for configuring a geo-location web service.

FIG. 5A illustrates an interface for monitoring a geolocation of a device.

FIG. 5B illustrates a method for providing a geolocation web service.

FIG. 6 is a block diagram of an exemplary computing device for implementing the present technology.

FIG. 7 is a block diagram of an exemplary mobile device for implementing the present technology.

### DETAILED DESCRIPTION

The present technology identifies the accurate geo location of the user of a geo-restricted web service, estimates the risk of the user subsequently exiting the allowed area, and estimates when the user location needs to be re-determined before any exit to the allowed area could happen. An action may then be performed based on the results of the re-geolocation.

An initial geo-location may be determined for a user of a web service from the user's connection data to establish if it is a mobile connection or not. Once the connection is identified as mobile or static and the user's location is known, the closest border and/or territory which is blocked to the user and within the geo-restricted area is determined. A future time at which the user's geo-location should be re-determined is then calculated using a variety of formula based on the connection type, location and distance to the border. The resulting calculation of desired future time of re-geolocation may be based on the user's current location, the distance to the nearest border, an estimated velocity at which the user may be moving, rules associated with the web-service, parameters set by an administrator and other factors. The recalculation may be performed at some time before the user reaches the blocked territory or border so that a risk can be determined before the user reaches the blocked territory or border. When the user's new location at that time is determined to be now closer to the border of the geo-restricted web service, an action may be taken by the web service in light of the updated geo data. The action may include for example performing a repeat calculation of the time required for the next re-geolocation (based on the formula described above), the user may be provided with a warning that they are close to an exclusion zone, and a portion or all of the service features provided to the user may be blocked, or some other action may be taken.

The present technology may determine location in more than one manner. For example, the location of a device may be determined using primary location geolocation data as well as secondary geolocation data. The primary geolocation data may include Wi-Fi connection data while secondary geolocation data may include an IP address associated with a landline through which a signal is provided.

In some embodiments, a secondary geolocation process may not be entirely accurate, for example when an ISP reports a user location as the corporate facility of a cell carrier rather than the location of the user device. To account for this, the present technology may inform an administrator of the discrepancy between the primary and secondary geolocation data, if they are different, and recommend contacting an ISP provided to confirm user location based on user carrier data as the secondary geolocation source.

In addition to geolocation data, a spoofing check may be used to determine the accuracy or trustworthiness of the geolocation data. The spoofing check may include examining the running processes on the device to confirm the device is not using software that could be used to spoof its location, such as for example a virtual private network (VPN). If the spoofing check results in detecting running processes that may be used to spoof a location, the information is provided to an administrator and the user access to a network may be revoked.

The type of connection may also be determined for use in determining the risk of the device moving to outside a geo-fenced area. Static connections, for example those from a desk-top computer, possess less risk than mobile connections, which imply that movement by the user is possible while maintaining a connection. Therefore, the frequency of determining the user location may be based at least in part on the distance of the user to a border of a geofenced area or geofence buffer as well as whether the device is detected to be a mobile device, e.g. a device using a mobile ISP to connect to the Internet.

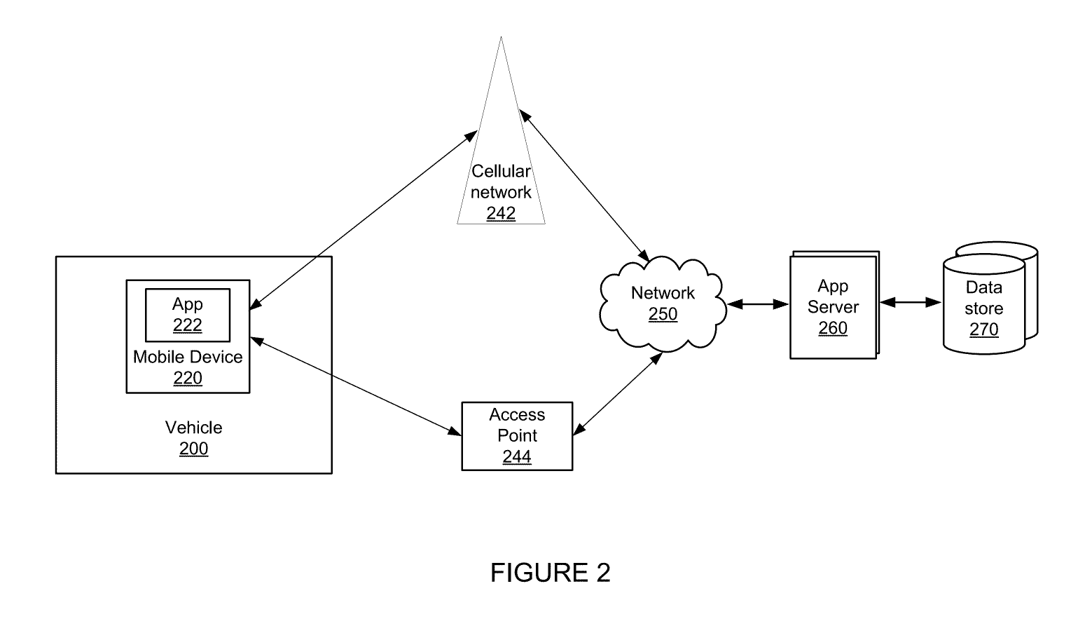

The functionality described herein may be provided by an application stored in memory of a mobile device and executed by a processor on the mobile device. The application is discussed in more detail with respect to the system of FIG. 2.

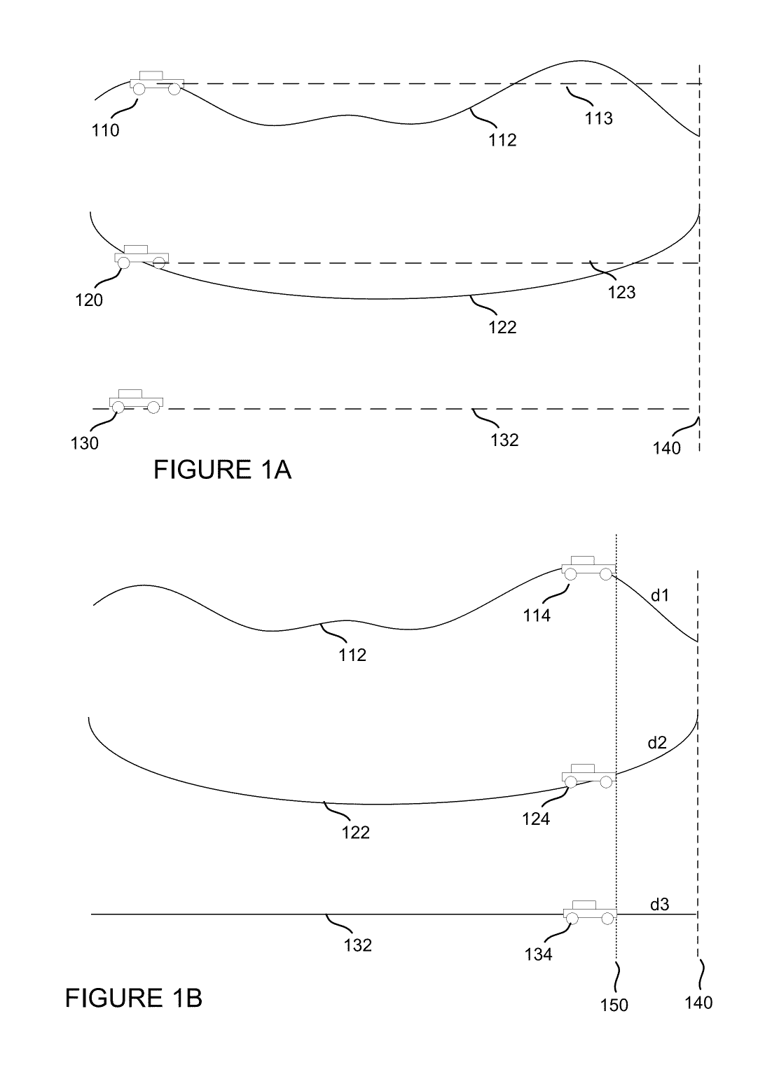

FIGS. 1A-1B illustrates information used in determining user geographical location. In FIG. 1A, a vehicle such as a car, train, or other moving vehicle may be accessing a geo-restricted web service through a mobile device. While accessing a mobile ISP, the user may be traveling along a path 112, 122 or 132. For example, for a user of a mobile device within vehicle 110, the vehicle may be traveling along route 112. To determine when the user position should be re-determined (i.e., re-geolocation should be performed), a straight line is determined from the vehicle 110 to border 140. A reasonable speed is assumed for the user, for example a maximum speed on a road, train track or other transportation route, and time required to get to a position 150 (see FIG. 1B) near the border is determined. At that time, the user's location is re-geolocated whether or not the user is moving in the direction of the border.

For example, whether the user with a mobile device is traveling along a curvy road 112, a non-straight train track 122, or a nearly straight road 132, a direct line 113, 123 or 132 to the border 140 of the geographic area associated with the website is determined. The time at which to re-geolocation should be performed may be associated with an estimated location of the user if they were traveling towards the nearest border of the geographic area. For example, the estimated location 150 may be associated with a distance d1, d2, or d3 away from the border 140. If the user's updated location at the time of geolocation in travel is determined to be closer to the border of the geo-restricted web service or a blocked territory, the risk of the user leaving the area is determined and an action may be taken by the web service, such as for example the user may be provided with a warning, a portion or all of the service features provided to the user may be blocked, or some other action may be taken.

FIG. 2 is a block diagram of a system for implementing the present technology. The system of FIG. 2 may include a vehicle 200, mobile device 220, cellular network 242, network 250, application server 260, and data store 270. Vehicle 200 may be traveling within a geographical area associated with a geo-restricted web service. Mobile device 220 may be implemented as a mobile device such as a smart phone, a tablet computer, or other device that may communicate with a mobile ISP, such as for example a computing device without built in cellular capability but able to access cellular signals via a dongle that connects via cellular towers. As used herein, a mobile device may be considered any device that is capable of communicating with one or more cellular towers via internal circuitry, external circuitry such as a dongle, or other means. Application 222 may communicate with one or more applications of application server 260 to perform functionality described herein.

Cellular network 242 may provide a mobile ISP to communicate with one or more mobile devices 220. Cellular network 242 may also communicate with network 250, and other devices, servers and networks. Data communicated over cellular network 242 may include voice, location, and other data. Network 250 may be implemented as the Internet, a private network, public network, intranet, or other network.

Application server 260 may include one or more application servers, network servers, and other machines which implement a geographically-restricted web service. The web service may be provided over network 250, cellular network 242, and one or more access points 244. Application server may include one or more applications that operate to access data from data store 270, communicate with application 222 on mobile device 220, and determine a geographical location of the mobile device. Application server 26 may include one or more applications which allow a user to configure the web service provided by application server 260, implement a rules engine, and perform other functionality as discussed herein.

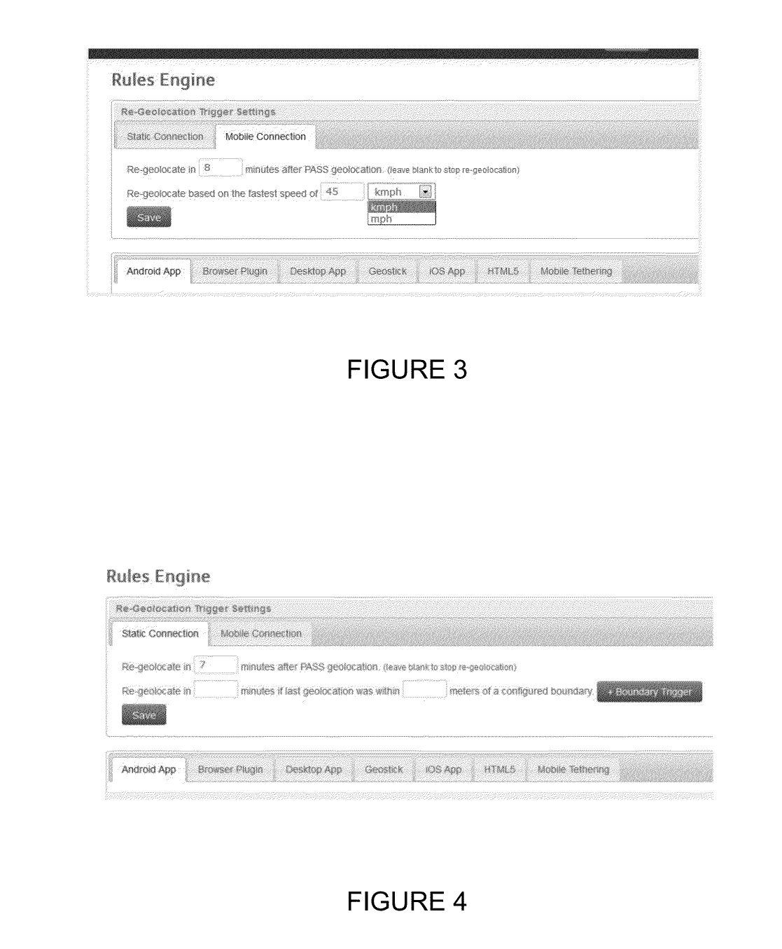

FIGS. 3-4 illustrates interfaces for configuring a geo-location web service. The interface of FIG. 3 allows an administrator to configure mobile connection settings. Exemplary mobile connection settings include configuring re-geolocation settings, including a time and/or based on a particular speed. The settings may be configured for different applications, such as for example an Android application, browser plug-in, desktop application, geostick, iOS application, HTML5 application, and mobile tethering.

The interface of FIG. 4 allows an administrator to configure static connection settings. Exemplary static connection settings include configuring re-geo-location settings, including a time at which to relocate. The time may be a static time or may be set to a time if the last geo-location was within a user-set distance from a configured boundary associated with a web service. The settings may be configured for different applications, such as for example an Android application, browser plugin, desktop application, geostick, iOS application, HTML5 application, and mobile tethering.

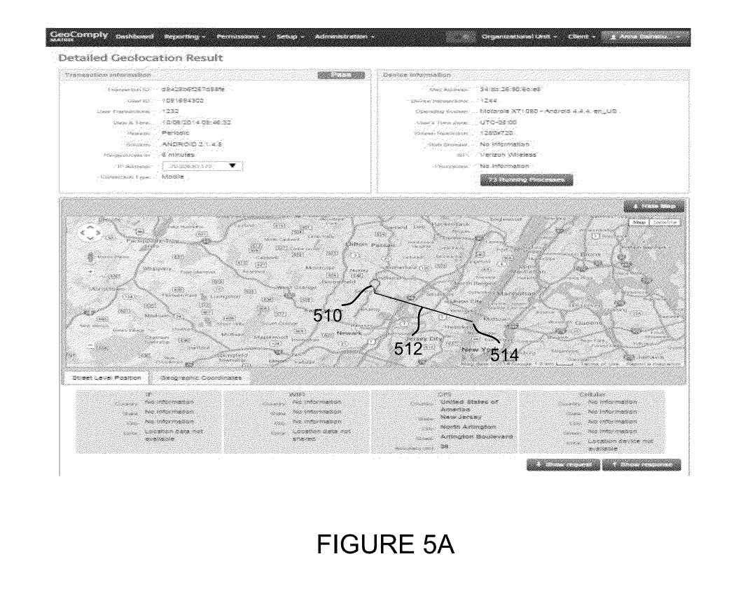

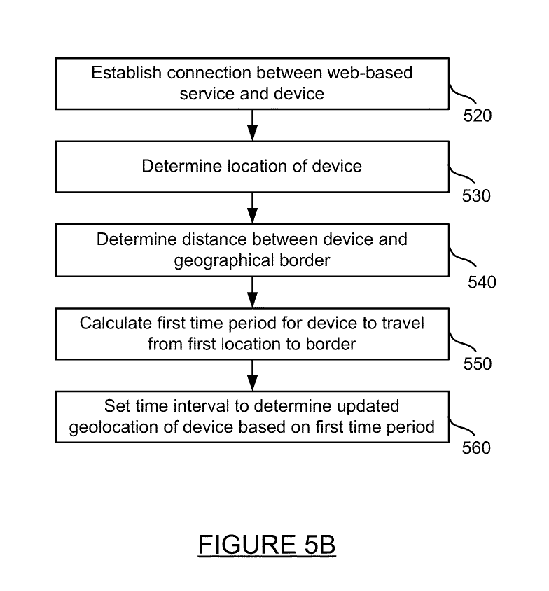

FIG. 5A provides an interface for monitoring a geolocation of a device. The interface of FIG. 5A provides transaction information, device information, geolocation information in a map, and geolocation information from other sources such as IP, WiFi, GPS And Cellular. The transaction information indicates a transaction ID, user ID, date and time, device type, re-geolocation information, connection type, and other data. The data may be detected from the device being monitored, for example via the agent installed on the device, while some data may be generated for the particular monitoring session. The device information may include a mac address, device id, operation system, screen information, web information, cellular provided, number of running processes, and other data. The information may be provided to a server by the application running on the device.

The geolocation data on the map provides location for the user on the map. From the map, an administrator may see the most recent geolocation data obtained for the user. In particular, a distance corresponding to straight line 512 may be calculated from user 510 to a border 514. Based on the distance, and assuming a speed of, for example, 65 MPH, the time to the border may be about 10 minutes. Therefore, the time to the next geolocation determination for the device may be made in six minutes (some time less than the time required to get to the border).

The other data in the interface of FIG. 5A may provide information retrieved from an IP provider, information retrieved from a WiFi signal, GPS information associated with the device and cellular data retrieved from the device. For each of these four types of information, the data may be retrieved by the agent on the device and the geolocation may be approximated for each type of data.

Mobile internet connections (including a player using a lap top on a train with a mobile dongle connection) by nature may pose a greater compliance risk than static connections as the player has the ability to move while maintaining their connection. For this reason, the present technology implements a specific re-geolocation method for mobile connections.

Static connections on the other hand (including a player connecting their mobile device to Wi-Fi in their home for example) may not represent the same risk of a player crossing a border while still connected. Therefore, these players with static connections may be subject to other re-geolocation settings implemented by the present technology. All re-geographic determination settings may be configurable by method of play (IOS native, PC Download, etc).

In embodiments, the present technology may first identify exactly where the player/user of a geo-restricted web service is when their session begins. The present technology measures from the player to the nearest exclusion zone, for example in a straight line or the distance along the closest travel route (road, train track, etc.). The present system then establishes when to re-geolocate the user at an interval which is before they could get to that exclusion zone. The present technology does this by assuming a speed, such as for example a maximum speed, to be confident that the user is not across the border before they are re-geolocated and the risk re-assessed. For example, the speed may be selected to be 80 miles an hour in an area having a 60 miles an hour speed limit.

With that speed configured, an algorithm implemented by the present technology then proposes a time for the re-geolocation. For example, if the user is 20 miles from the border/exclusion zone, then the present system would propose a re-geolocation within 15 minutes, 12 minutes or some other time period that would expire before the user is estimated or determined to be at the border or the exclusion zone.

Once the system configures the speed wanted to assume as a prudent velocity in a straight line from the users location at start of the session to the exclusion zone, then the calculations and process occurs automatically. As for a static connection, a user or administrator can choose if/how the system re-geolocates players based on their proximity to borders. The settings are configurable by method of play (IOS native, PC Download, etc).

FIG. 5B illustrates a method for determining a geolocation of a device. First, a connection is established between a web-based service and a device. At step 520. Next, the location of the device is determined at step 530. The distance between the device and a geographical border may be determined at step 540. The geographical border may include a business perimeter, a city, a state or some other area for which a geofence can be configured. Next, a time period for the device to travel from it's location determined in step 530 to the border is determined at step 550. The time period may be based on geographical data of the device and border as well as an assumed speed, such as a maximum speed, for the device. A time interval may then be set at which the geolocation of the device should be redetermined. The time interval should be set so that the device should still be within the geofenced area and will not have reached or crossed the border. If the device is determined to be closer to the border, an alert may be generated to the user or to an administrator regarding the travel of the device. Other actions may be taken as well, for example throttling the connection to the device, terminating the connection, sending the device a message or warning, and other actions based on the apparent direction of the device with respect to the border.

The present technology functions low on power and processing cycles. The present technology only suggests a rapid re-geolocation when the situation genuinely justifies it.

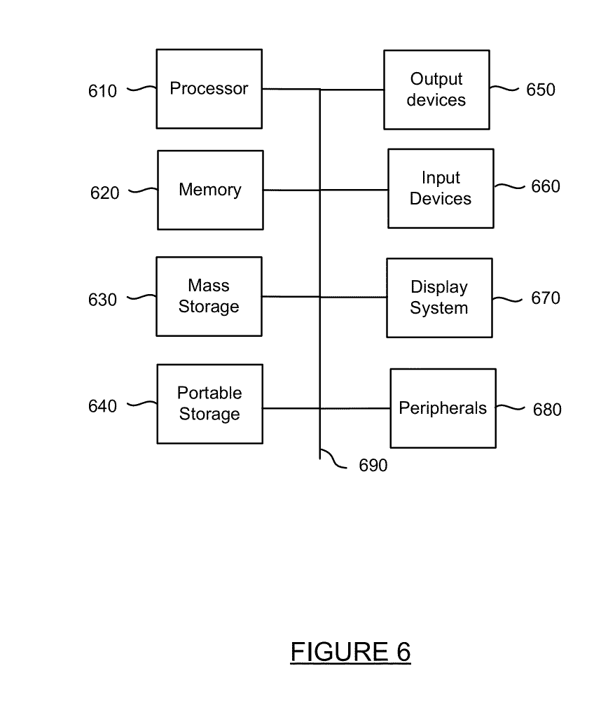

FIG. 6 is a block diagram of an exemplary computing device for implementing the present technology. FIG. 6 illustrates an exemplary computing system 600 that may be used to implement a computing device for use with the present technology. System 600 of FIG. 6 may be implemented in the contexts of the likes of devices forming cellular network 242 and access point 244, application server 260, and data store 270. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

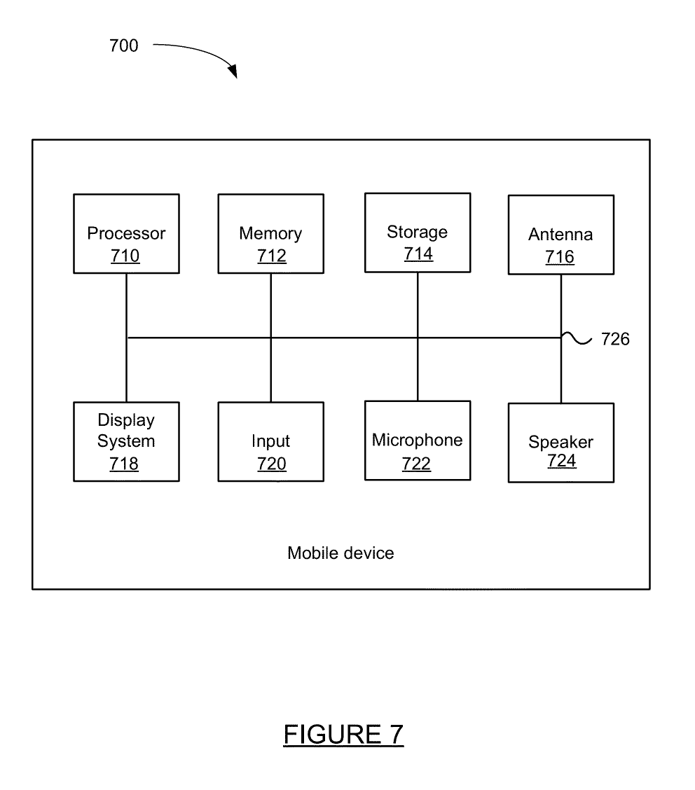

FIG. 7 illustrates an exemplary mobile device system 700 that may be used to implement a mobile device for use with the present technology, such as for mobile device 220. The mobile device 700 of FIG. 7 includes one or more processors 710 and memory 712. Memory 712 stores, in part, programs, instructions and data for execution and processing by processor 710. The system 700 of FIG. 7 further includes storage 714, one or more antennas 716, a display system 718, inputs 720, one or more microphones 722, and one or more speakers 724.

The components shown in FIG. 7 are depicted as being connected via a single bus 726. However, the components 710-824 may be connected through one or more data transport means. For example, processor unit 710 and main memory 712 may be connected via a local microprocessor bus, and storage 714, display system 718, input 720, and microphone 722 and speaker 724 may be connected via one or more input/output (I/O) buses.

Memory 712 may include local memory such as RAM and ROM, portable memory in the form of an insertable memory card or other attachment (e.g., via universal serial bus), a magnetic disk drive or an optical disk drive, a form of FLASH or PROM memory, or other electronic storage medium. Memory 712 can store the system software for implementing embodiments of the present invention for purposes of loading that software into main memory 710.

Antenna 716 may include one or more antennas for communicating wirelessly with another device. Antenna 716 may be used, for example, to communicate wirelessly via Wi-Fi, Bluetooth, with a cellular network, or with other wireless protocols and systems. The one or more antennas may be controlled by a processor 710, which may include a controller, to transmit and receive wireless signals. For example, processor 710 execute programs stored in memory 712 to control antenna 716 transmit a wireless signal to a cellular network and receive a wireless signal from a cellular network.

Display system 718 may include a liquid crystal display (LCD), a touch screen display, or other suitable display device. Display system 718 may be controlled to display textual and graphical information and output to text and graphics through a display device. When implemented with a touch screen display, the display system may receive input and transmit the input to processor 710 and memory 712.

Input devices 720 provide a portion of a user interface. Input devices 720 may include an alpha-numeric keypad, such as a keyboard, for inputting alpha-numeric and other information, a touch-screen, microphone, camera, buttons or switches, a trackball, stylus, or cursor direction keys.

Microphone 722 may include one or more microphone devices which transmit captured acoustic signals to processor 710 and memory 712. The acoustic signals may be processed to transmit over a network via antenna 716.

Speaker 724 may provide an audio output for mobile device 700. For example, a signal received at antenna 716 may be processed by a program stored in memory 712 and executed by processor 710. The output of the executed program may be provided to speaker 724 which provides audio. Additionally, processor 710 may generate an audio signal, for example an audible alert, and output the audible alert through speaker 724.

The mobile device system 700 as shown in FIG. 7 may include devices and components in addition to those illustrated in FIG. 7. For example, mobile device system 700 may include an additional network interface such as a universal serial bus (USB) port.

The components contained in the computer system 700 of FIG. 7 are those typically found in mobile device systems that may be suitable for use with embodiments of the present invention and are intended to represent a broad category of such mobile device components that are well known in the art. Thus, the computer system 700 of FIG. 7 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for determining a geographical location, comprising:
establishing a connection between a web-service provided by a remote server and a device;
determining a first location of the device by an application executing on the device, the first location being a current location at a first period of time;
determining a distance between the device and a geographical border;
calculating a first time period for the device to travel from the first location to the geographical border;
setting a time interval at which to determine an updated location for the device, the time interval less than the first time period.

2. The method of claim 1, wherein the time interval at which the second location is determined is based on the first location and a geographic boundary associated with the web-service.

3. The method of claim 1, where in the distance is determined as a straight line.

4. The method of claim 1, wherein the time interval is determined by calculating the distance traveled by the device at a first velocity.

5. The method of claim 1, wherein the velocity is based on a roadway speed limit.

6. The method of claim 1, determining as second location of the device by the application at the time interval, the second location being a current location at a second point in time,

7. The method of claim 1, wherein the web-service is a geographically restricted web service.

8. The method of claim 1, further comprising determining a time at which to update the location of the device.

9. The method of claim 1, wherein determining the first location includes determining a first location using primary geolocation data and a second location using secondary geolocation data.

10. The method of claim 1, further comprising determining if any process running on the device matches an entry in a list of forbidden running processes.

11. The method of claim 10, wherein the list of running processes includes running processes used to provide in false geolocation data.

12. The method of claim 1, further comprising determining a connection type to be either static or mobile.

13. The method of claim 12, assigning a risk to the device based on the connection type.

14. The method of claim 1, wherein the device is a mobile device.

15. The method of claim 1, wherein the device connects to the webs service via a tongle which accesses a cellular network.

16. A computer readable non-transitory storage medium having embodied thereon a program, the program being executable by a processor to perform a method for determining a geographical location, the method comprising
establishing a connection between a web-service provided by a remote server and a device;
determining a first location of the device by an application executing on the device, the first location being a current location at a first period of time;
determining as second location of the device by the application, the second location being a current location at a second period of time,
wherein the time at which the second location is determined is based on the first location and a geographic boundary associated with the web-service.

17. A system for determining a geographical location, the system including:
a processor;
a memory;
an application stored in memory and executed by the processor to establish a connection between a web-service provided by a remote server and a device, determine a first location of the device by an application executing on the device, the first location being a current location at a first period of time, determine as second location of the device by the application, the second location being a current location at a second period of time, wherein the time at which the second location is determined is based on the first location and a geographic boundary associated with the web-service.
